(19) United States
(12) Patent Application Publication
(10) Pub. No.: US 2010/0092245 A1
(43) Pub. Date: Apr. 15, 2010

(54) PIPE SETTING TOOL

(76) Inventor: Patrick C. Fitzsimons, Potterville, MI (US)

Correspondence Address: BUTZEL LONG;IP DOCKETING DEPT, 350 SOUTH MAIN STREET, SUITE 300, ANN ARBOR, MI, 48104, US

(21) Appl. No.: 12/576,786

(22) Filed: Oct. 9, 2009

Related U.S. Application Data
(60) Provisional application No. 61/104,143, filed on Oct. 9, 2008.

(51) Int. Cl. F16L 1/036; E03F 3/06

(52) U.S. Cl. 405/184

(57) ABSTRACT

A pipe setting tool for use with an excavator includes a frame having sidewalls, a lower wall positioned at a lower edge of the side walls and a rear wall positioned at a side edge of the sidewalls. The frame is detachably coupled to the excavator. A cushioning member is disposed on an outer surface of the lower wall and on an inner surface of the rear wall. The cushioning member is in contact with a surface of the pipe as the pipe is displaced to join the pipe with another pipe.

### CROSS REFERENCE TO RELATED APPLICATIONS

This application claims the benefit of an priority to U.S. Provisional Patent Application Ser. No. 61/104,143, filed Oct. 9, 2008 and which is incorporated herein by reference in its entirety.

### BACKGROUND

1. Field

The present apparatus relates generally to an attachment for an excavator and more specifically for a pipe setting attachment for an excavator.

2. Description of the Related Art

Excavators are frequently utilized in construction, and can perform a wide variety of tasks. For example, excavators can be utilized in digging of trenches, holes or foundations, material handling, land clearing, demolition, grading or landscaping, lifting and or laying of objects, mining or dredging or the like. To accomplish these various tasks, the excavator may be capable of receiving an attachment to accomplish a particular task. For example, the attachment may be a bucket, an auger, a hammer, a grapple, a rake or the like. The attachment mounting may utilize a quick coupling to facilitate removal and installation of the attachment.

The excavator may frequently be utilized to dig and lay a plurality of pipes end to end within a trench. An example of a type of pipe is a concrete pipe. Various styles of attachments may be utilized to lay the pipe and or join the pipes. The excavators are well suited to this type of activity. However, the pipe may be damaged during the installation process, especially when interconnecting the pipes. Therefore, the American Society of Testing Materials has set forth standards to protect the integrity of the pipe during installation. These standards state that a mechanical device may not be utilized to push a pipe into position with respect to the existing pipe. In order to comply with the ASTM standards, contractors presently set or join the pipes together by hand. This significantly reduces the amount of pipe that can be laid in one day from about 400 feet per day to 100 feet per day. Thus, there is a need in the art for an improved pipe setting tool.

### SUMMARY

Accordingly, the present invention is a pipe setting tool for use with an excavator in setting a pipe. The pipe setting tool includes a frame having sidewalls, a lower wall positioned at a lower edge of the side walls and a rear wall positioned at a side edge of the sidewalls. The frame is detachably coupled to the excavator. A resilient bumper or cushioning member is disposed on an outer surface of the lower wall and on an inner surface of the rear wall. The cushioning member is in contact with a surface of the pipe as the pipe is positioned with respect to another pipe.

Also provided, a method of setting pipe using an excavator, the method comprising the steps of attaching a pipe setting apparatus to the excavator, the pipe setting apparatus having sidewalls, a lower wall positioned at a lower edge of the side walls, a rear wall positioned at a side edge of the sidewalls, and a cushioning member disposed thereon; positioning the pipe setting apparatus against a first pipe to be set, such that the cushioning member is placed in contact with the surface of the pipe; and using the pipe setting apparatus to move the first pipe towards a second pipe to thereby join the first pipe with the second pipe.

One advantage of the present device is that a pipe setting tool is provided that can quickly be attached to a free end of an excavator. Another advantage of the present device is the pipe setting tool includes a cushioning member to protect the pipe during installation and setting into place. A further advantage of the present device is that use of the pipe setting tool increases the speed and accuracy of laying pipe.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is an elevational view of an excavator laying pipe.

FIG. 2 is a side view of a pipe setting tool for use with the excavator of FIG. 1.

FIG. 3 is an enlarged side view of the pipe setting tool of FIG. 2.

FIG. 4 is an enlarged rear view of the pipe setting tool of FIG. 2.

FIG. 5 a front view of the pipe setting attachment of FIG. 2.

FIG. 6 is an elevated view of the excavator of FIG. 1 with the pipe setting tool of FIG. 2 attached thereto.

FIG. 7 is a flow chart diagram of a method of using an excavator to lay pipe.

### DETAILED DESCRIPTION

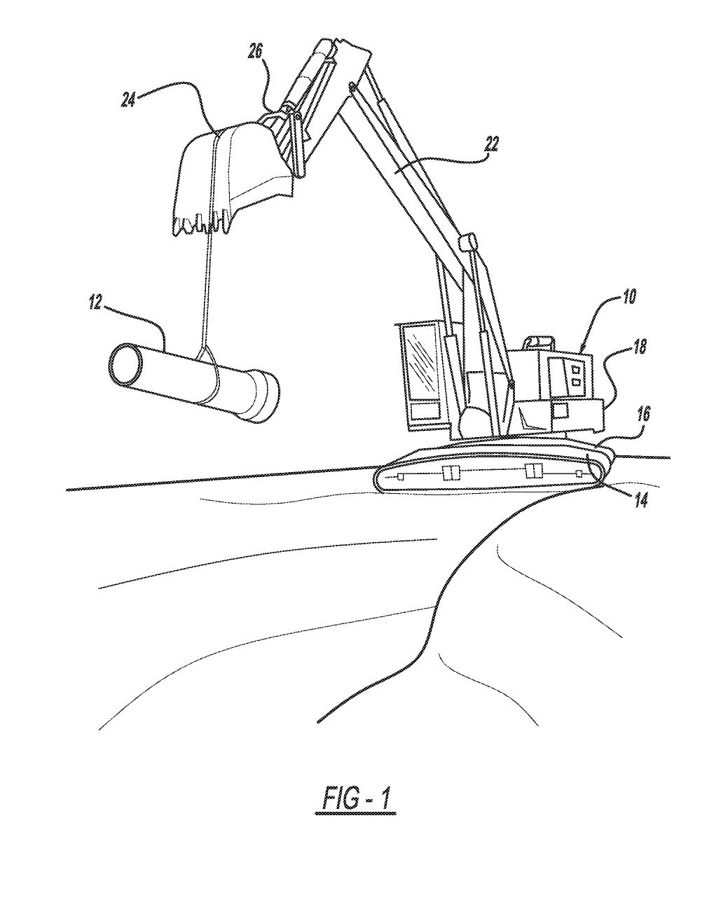

Referring to FIG. 1, an excavator 10 is illustrated. In this example, the excavator 10 is utilized in laying pipe 12, such as concrete pipe. The excavator 10 includes a base 14. The base 14 may include an under carriage 16 or wheels. A platform 18 is rotatably mounted to the base 14. A cab 20 for an operator may be mounted to the platform 18. One end of an articulating arm 22 is mounted to the platform 18 and a free end of the arm has a working attachment tool such as the pipe laying tool 24 of this example secured thereto using a coupling device 26. Various styles of coupling devices are considered, such as a quick connect coupler that provides for the coupling or uncoupling of an attachment tool. A quick connect coupler increases the versatility of the excavator 10.

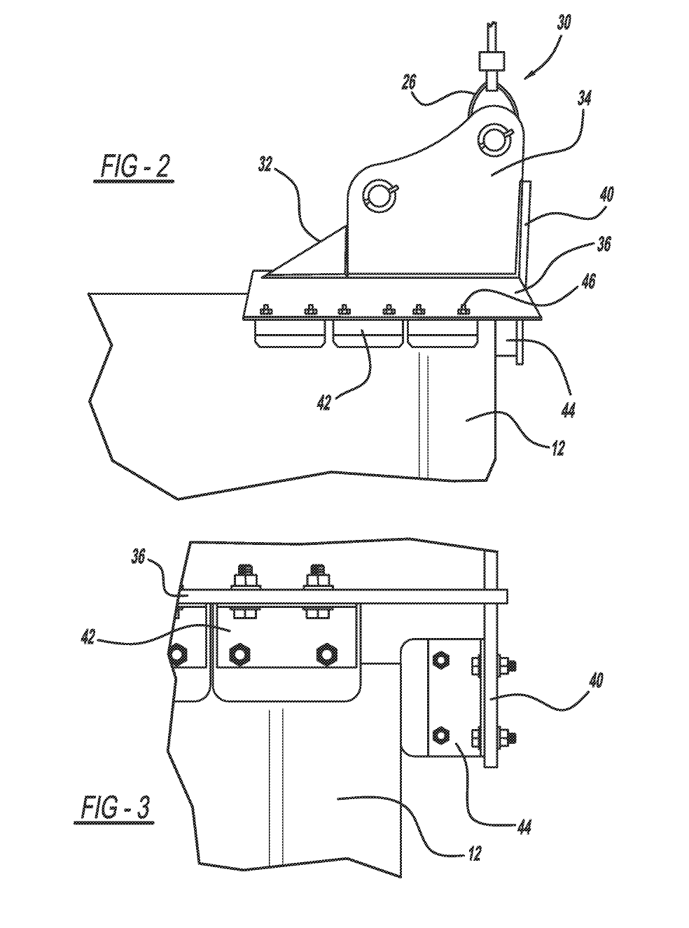

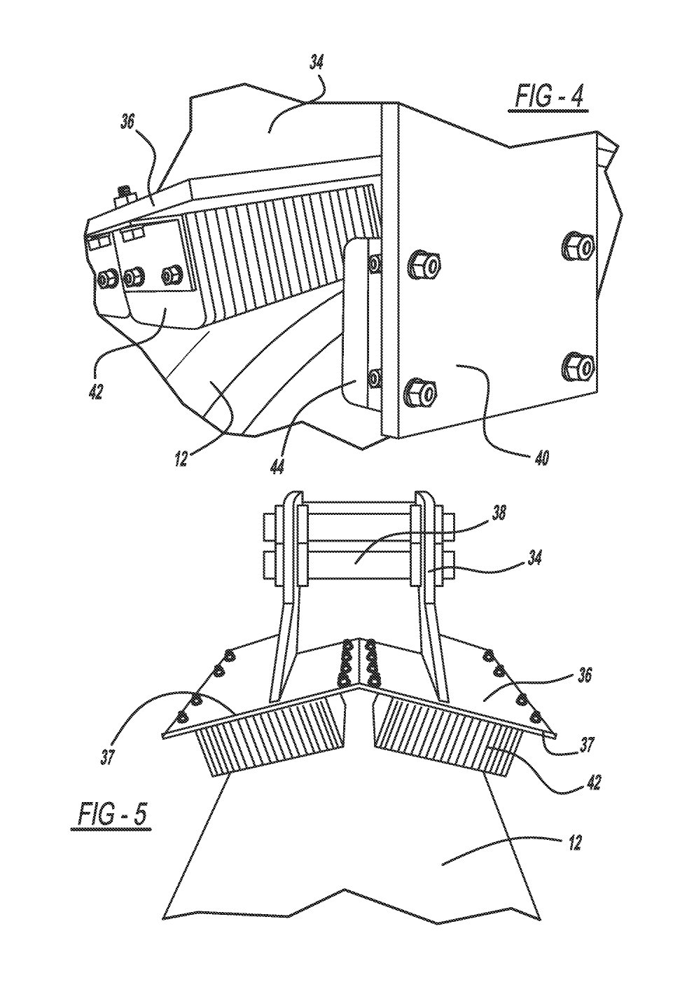

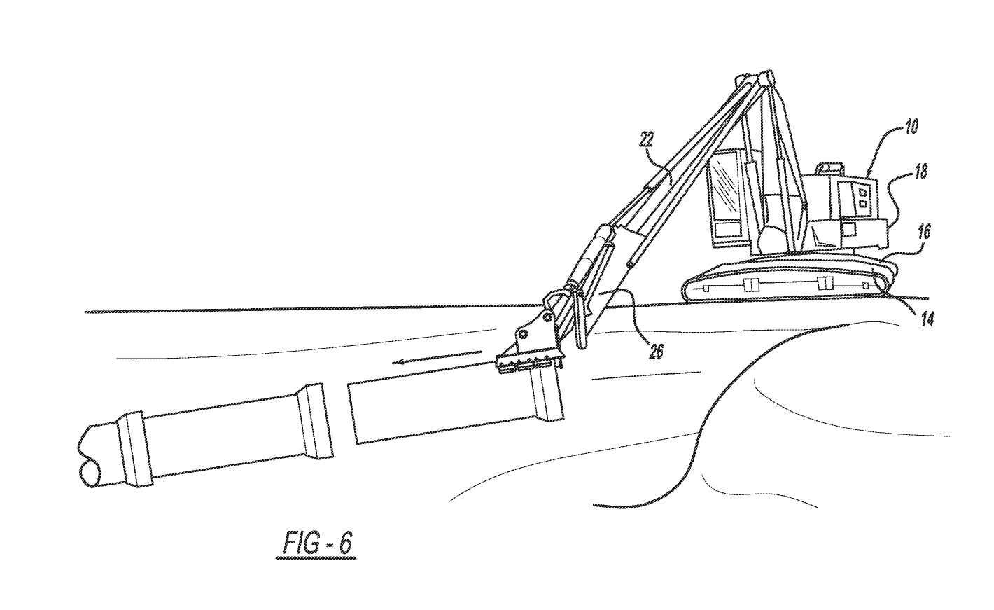

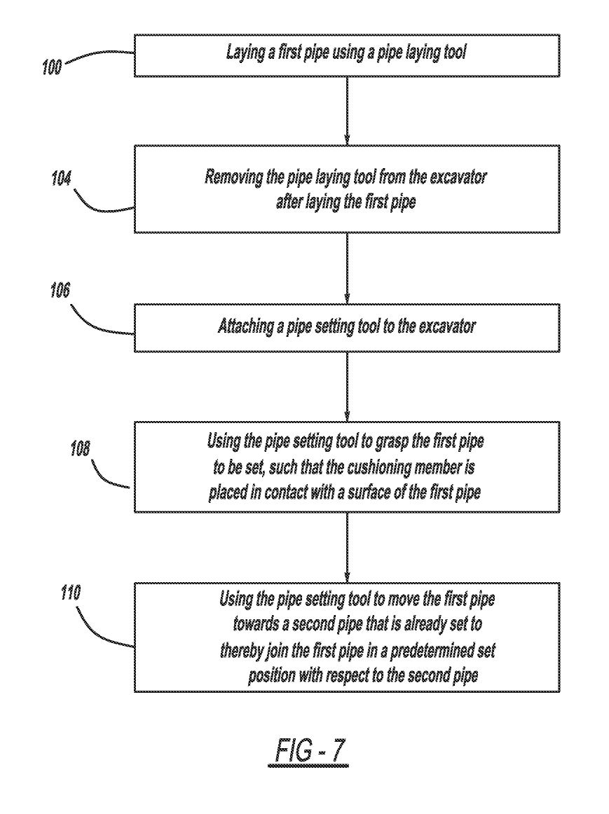

Referring to FIGS. 2-6, pipe setting tool 30 for use with an excavator is illustrated. As shown in FIG. 6, the pipe setting tool 30 is secured to the free end of the excavator 10 arm, such as using a coupling device 26, via fasteners (e.g., pins, bolts, clamps, etc.). The pipe setting tool includes a frame 32. The frame 32 includes two generally planar side walls 34, and a generally planar lower wall 36 located at a lower end of the side walls 34. The lower wall 36 may have a slight “V” shape, thus forming two wings 37. The frame 32 may include a cross member 38 disposed between the side walls 34. The cross members 38 may provide structural support to the frame 32. In addition, an upper cross member 38 may be engaged by the coupling device 26, to connect the pipe setting tool 30 with the excavator 10 arm. The frame 32 also includes a rear wall 40 that is positioned at an end of the lower wall 36 so that it is perpendicular to the lower wall 36 and adjacent an outer edge of the side walls 34.

A cushioning member 42 is disposed on a lower surface of the lower wall 36 and projects outwardly. The attachment tool 30 may include a plurality of cushioning members 42. The cushioning member 42 is generally rectangular, and a plurality of cushioning members may be spaced apart along each wing 37. In this example, the cushioning member 42 is attached to the lower wall 36 using a fastener 46, such as a bolt or the like. In another example, the cushioning member 42 is attached to the lower wall 36 using an adhesive. Other attachment means are contemplated. The cushioning member 42 is resilient in order to absorb any forces generated during displacement of the pipe into a joined position with another pipe, but can push the pipe into position. In this example, there are six cushioning members 42 positioned on the wing 37. An example of a cushioning member 42 is a rubber bumper. In addition, a second cushioning member 44 may be disposed on an inner surface of the rear wall 40, such that the second cushioning member 44 projects inwardly from an inner surface of the rear wall 40. The second cushioning member 44 is in contact with the open end of the pipe 12 and exerts a force on the open end of the pipe 12 to set the pipe 12 into position with an adjoining pipe. For example, the first or second cushioning member 42, 44 may be a rectangular member having a length of about 12 inches, a width of about 6 inches, and a height of about 4 inches.

The pipe setting tool 30 increases the contact surface area between the pipe setting tool 30 and the pipe 12, to reduce the opportunity for damage to the pipe 12. The pipe setting tool 30 may be self adjustable due to the angle of each of the wings 37, to accommodate various pipe diameters (e.g., twelve inch to forty-eight inch pipes, etc.). For example, the pipe setting tool may be self adjusted by adjusting the angle of the wings (shoes). The self adjusting mechanism is also inherent with respect to the cushion members (rubber bumpers) which may splay away from a force exerted thereon. For example, as the pipe setting tool is positioned against a surface of a pipe, the cushion members are compressed and forced to extend apart outwardly to the extent needed to accommodate a given pipe having a particular diameter.

In operation, an excavator 10 with a pipe laying tool 24 attached to the arm is utilized to place the pipe in a predetermined location, such as in a trench. As shown in FIG. 1, the excavator 10 picks up a section of pipe 12 using the pipe laying tool 24, and lays the pipe in the predetermined location. The pipe 12 is positioned so that the mating end of the pipe being laid is adjacent the receiving end of the already joined pipes. The pipe laying tool is removed from the arm 22, and the pipe setting tool 30 is attached to the arm 22 via the quick connect coupling 26. The pipe setting tool 30 is positioned by the operator with respect to the pipe 12 to be in place, such that the rear wall 40 of the pipe setting tool is adjacent the receiving end of the pipe and the lower wall 36 of the pipe setting tool is adjacent the outer surface of the pipe. The cushioning member 42, 44 is in contact with a surface of the pipe 12. The mating end of the pipe 12 is slid into position with respect to the receiving end of the already joined pipes (i.e., “pushing the pipe home”) to form a joint. The joint between the pipes may be further sealed.

It should be appreciated that the excavator may include additional features that are well understood in the art, such as a motor, operating controls, or the like.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims the present invention may be practiced other than as specifically described.

What is claimed is:

1. A pipe setting tool for use with an excavator in setting a pipe comprising:
a frame having sidewalls, a lower wall positioned at a lower edge of the side walls and a rear wall positioned at a side edge of the sidewalls, wherein the frame is detachably coupled to the excavator; and
a cushioning member disposed on an outer surface of the lower wall and on an inner surface of the rear wall, wherein the cushioning member is a resilient member that is in contact with a surface of a first pipe as the first pipe is displaced to set the first pipe in a predetermined position that is adjacent a second pipe that is already set.

2. The pipe setting tool of claim 1, further comprising a plurality of cushioning members disposed on the outer surface of the lower wall and on the inner surface of the rear wall.

3. The pipe setting tool of claim 2, further comprising six cushioning members disposed on the outer surface of the lower wall and two cushioning members disposed on the inner surface of the rear wall.

4. The pipe setting tool of claim 3, wherein the cushioning members have a length of approximately 12 inches, a width of approximately 6 inches, and a height of approximately 4 inches.

5. The pipe setting tool of claim 1, wherein the cushioning member is a rubber bumper.

6. The pipe setting tool of claim 1, wherein the lower wall has a V-shape profile that forms a pair of wing members.

7. The pipe setting tool of claim 6, wherein the pipe setting tool includes an adjustment mechanism for adjusting an angle between the pair of wing members.

8. The pipe setting tool of claim 1, further comprising a cross member disposed between the side walls.

9. The pipe setting tool of claim 8, wherein the cross member is engageable by a coupling device of the excavator to thereby couple the pipe setting apparatus to an arm of the excavator.

10. A pipe setting tool for use with an excavator in setting a pipe comprising:
a frame having sidewalls, a lower wall positioned at a lower edge of the side walls and a rear wall positioned at a side edge of the sidewalls, wherein the frame is detachably coupled to the excavator;
a cushioning member disposed on an outer surface of the lower wall and on an inner surface of the rear wall, wherein the cushioning member is a resilient member that is in contact with a surface of a first pipe as the first pipe is displaced to set the first pipe in a predetermined position that is adjacent a second pipe that is already set; and
wherein the lower wall has a V-shape profile that forms a pair of wing members.

11. The pipe setting tool of claim 10, further comprising a plurality of cushioning members disposed on the outer surface of the lower wall and on the inner surface of the rear wall.

12. The pipe setting tool of claim 11, further comprising six cushioning members disposed on the outer surface of the lower wall and two cushioning members disposed on the inner surface of the rear wall.

13. The pipe setting tool of claim 12, wherein the cushioning members have a length of approximately 12 inches, a width of approximately 6 inches, and a height of approximately 4 inches.

14. The pipe setting tool of claim 10, wherein the cushioning member is a rubber bumper.

15. The pipe setting tool of claim 10, wherein the pipe setting tool includes an adjustment mechanism for adjusting an angle between the pair of wing members.

16. The pipe setting tool of claim 10, further comprising a cross member disposed between the side walls; and wherein the cross member is engageable by a coupling device of the excavator to thereby couple the pipe setting apparatus to an arm of the excavator.

17. A method of setting a pipe using an excavator, the method comprising the steps of:
attaching a pipe setting tool to the excavator, the pipe setting tool having sidewalls, a lower wall positioned at a lower edge of the side walls, a rear wall positioned at a side edge of the sidewalls, and a cushioning member disposed thereon;
using the pipe setting tool to grasp a first pipe to be set, such that the cushioning member is placed in contact with a surface of the first pipe; and
using the pipe setting tool to move the first pipe towards a second pipe that is already set to thereby join the first pipe in a predetermined set position with respect to the second pipe.

18. The method of claim 17 further including the step of laying the first pipe using a pipe laying tool.

19. The method of claim 18 further including the step of removing the pipe laying tool from the excavator after laying the first pipe.
